(19) United States
(12) Patent Application Publication
(10) Pub. No.: US 2010/0318669 A1
(43) Pub. Date: Dec. 16, 2010

(54) Human Interactive Proof System and Apparatus that Enables Public Contribution of Challenges for Determining Whether an Agent is a Computer or a Human

(76) Inventor: Kevin Chugh, East Aurora, NY (US)

Correspondence Address: Kevin Chugh, 63 Center Street, East Aurora, NY, 14052, US

(21) Appl. No.: 12/815,741

(22) Filed: Jun. 15, 2010

Related U.S. Application Data
(60) Provisional application No. 61/187,418, filed on Jun. 16, 2009.

(51) Int. Cl. G06F 15/16; H04L 9/32

(52) U.S. Cl. 709/229; 726/5

(57) ABSTRACT

This patent describes a human, crowdsourced spambot prevention system that is an alternative to CAPTCHA, and is easy for humans to solve but difficult for bots. Humans submit challenges in the form of pictures and questions and answers that reference those images, and as a reward, when those challenges are presented to user agents, the submitter's link is presented as well, with the intent that there is value for a submitter to have his or her link presented to users.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Over the past few years, hackers and spammers have mastered the art of creating automated agents to flood web forums, e-mail inboxes, and other destinations with malicious postings or unsolicited commercial advertisements. These spammers write automated agents, or “bots” to, for example, automatically sign up for free e-mail accounts or automatically add comments to web pages, or postings to forums. They then send e-mails or post comments advertising a product or containing some other nuisance communication.

To date, the best defense of this technique is the CAPTCHA, which is an acronym for “Completely Automated Public Turing test to tell Computers and Humans apart.” A typical CAPTCHA is a series of numbers or letters that are distorted, or noise enhanced so that humans can recognize the letters or numbers, but computers cannot. An example CAPTCHA is shown in FIG. 1.

The problem with CAPTCHAs is that they are often difficult for humans to recognize, resulting in a frustrating experience for some users. Additionally, they are often prone to brute force attacks in efforts to circumvent their intent. These attacks include copying the URL of the CAPTCHA images, and asking groups of people to enter the correct answer. There are even websites that pay users to enter the answer strings to CAPTCHA challenges.

Other approaches to bot detection have been suggested, such as puzzles (for example, asking the user to arrange tiles in a particular order or asking the user to complete a small crossword puzzle entry), or asking the user to click in a particular area of an image, giving instructions that presumably only a human can understand, such as “click the pony in the image.” Another alternative to CAPTCHA is image recognition, in which a user is presented with an image, and the user is asked to complete some action, such as answering a question, associated with that image. For example, a user may be asked to identify what an image is by selecting a choice from a drop down list. Or, a user may be presented with a set of images and asked to click on all of the cats in the set. There are other variations on this approach. This genre of challenges is not strictly defined as a CAPTCHA, because it is not “completely automated,” however, given a large enough set of images, image recognition can potentially replace CAPTCHA as a more user-friendly, and just as effective method for keeping bots out of online forums, etc.

Image recognition challenges hold great promise as an alternative to CAPTCHAs, however, it is difficult for smaller websites to gain access to a large enough set of images and challenges corresponding thereto to present a difficult challenge to hackers. Access to such a large collection would be possible if a community of such images was established which allowed users to upload, and subsequently share images, and other types of media, along with human-created challenges.

The internet has fostered community contribution to large datasets, where each individual person contributes a small asset, and those assets are pooled into a large community asset. Wikipedia, for example, allows millions of users to write a handful of articles, and then allows everyone in the world to access the pool of articles.

If there were a way to establish a pool of bot detection challenges and then make that pool accessible to small and large websites, the CAPTCHA shortcomings could be avoided, and a community resource could be established that helped thousands of web sites avoid spam and other nuisance communications.

If such a pool of challenges (challenge media, such as pictures and audio, questions, and answers) existed, there would still be many vulnerabilities to attack unless designed properly. There are two specific techniques that spammers and hackers have tried to break bot detection technologies. One such attack, referred to here as a reference attack, is where a hacker saves the unique identifier of the challenge (such as the URL or filename) and stores the answer to that challenge in a database, referring to that database next time that challenge is issued. This type of attack is possible when a challenge technology fails to mask a unique identifier to a particular challenge. Anytime the hacker or spammer sees this identifier in the future, he or she is assured that a previous valid entry will remain valid. A second type of attack, a computer vision attack, attempts to discern the answer to a challenge by figuring out the contents of the challenge media. In the case of CAPTCHA, the domain of the challenge is letters and numbers, so this type of system is attacked with the premise that the answer will be a combination of letters and numbers. Hackers attempt to separate the CAPTCHA into individual characters, and then devise recognition algorithms to detect each character, for example.

The availability of a pool of challenges, contributed by the world community via the internet, along with an attack risk-minimized implementation has the potential to both increase the security of web sites, e-mails and other online media, as well as make such media more user friendly by removing cumbersome and awkward challenges.

### BRIEF SUMMARY OF THE INVENTION

The invention now described is a system and apparatus for presenting an image recognition challenge or other challenge to a user to prove that it is human, which is both resistant to a dictionary attack, and a pattern recognition attack, and where such challenges and their supporting media can be contributed by the public. The system allows large numbers of users to contribute images and other media and corresponding challenges (questions and answers, for example) to a central repository, and enables many web sites and other services to access this pool of challenges for the deterrence and prevention of spam communications.

The invention comprises a challenge server, which is made up of one or more computers that accept requests from other entities and send responses to other entities, a contributor entity, which is comprised of one or more computers or other devices which allow users to upload challenges to the challenge server, and a consumer entity, which is comprised of one or more computers which request challenges from the challenge server, present challenges to a user agent, and get verification from the challenge server as to whether the user agent passed or failed the challenge.

### BRIEF DESCRIPTION OF THE SEVERAL VIEWS OF THE DRAWING

FIG. 1—a CAPTCHA image, used to for verifying that the user is a human.

FIG. 2—The preferred embodiment of the invention

FIG. 3—A consumer entity—challenge server request/response cycle, preferred embodiment

FIG. 4—A consumer entity—challenge server request/response cycle, alternate embodiment

FIG. 5—An embedded challenge widget

FIG. 6—A web server/web client consumer entity—challenge server request/response cycle

FIG. 7—Contributing entity submitting a challenge, preferred embodiment.

### DETAILED DESCRIPTION OF THE INVENTION

The system works as follows. A pool of challenges is created by allowing users from the public to upload challenges to a central challenge server. The uploading user selects an image, audio file, or other media, and enters one or more questions that reference that media. In the case of an audio file, the question may be contained in the audio file itself, obviating the need for a separate question. The user also enters one or more answers that are acceptable answers to the one or more questions. This is accomplished in the preferred embodiment, with a web server that serves an HTML form to a contributing user, and that allows the user to specify the data just described.

The second function of the challenge server is to serve challenges and validate answers to external entities that request such services. This is accomplished as follows. The challenge server receives a request from an outside entity, called the consumer entity, which may be a client or user agent, or a web server or other server or computer, or a combination of a client machine and server machine, as in the case of a web client and web server requesting a challenge. A challenge may be any kind of human interactive proof that attempts to distinguish between a human and a computer or script. In the preferred embodiment, a challenge is an image and a question about the image, such as “What is the boy holding in this picture?”

The challenge server chooses a challenge from its database and sends a challenge package comprising a unique challenge identifier and zero or more of {a picture or pictures, a question or questions to pose to the user agent to determine whether that user agent is a robot or human, an answer or answers to that challenge in plain text form or in some hashed form}. In the preferred embodiment, the unique challenge identifier identifies an instance of a challenge so that the unique identifier of the challenge is hidden from the consumer entity. Those skilled in the art will recognize that this is readily implementable using a reference table in a database whose records contain a field that references the unique identifier to a record in a challenges table, for example. Using a unique identifier to an instance of a challenge has further advantages in addition to hiding the unique identifier to the challenge. An instance identifier provides further security for recordkeeping and the creation and enforcement of rules without ever altering the challenge record itself. When an instance is created, the requestor identifier (the unique id of the web site requesting a challenge, for example) can be recorded with the instance identifier, allowing monitoring of a particular requestor's challenge status. If a consumer entity is found, for example, to have a below average pass rate, it may be inferred that the consumer entity is suspicious. If the response rate (the number of times an answer is submitted or the status of an instance is requested) is below average, it may be inferred that a consumer entity is attempting to catalog a large number of challenges for the purposes of attempting to crack the system.

It should also be noted that an image may be slightly altered before being sent to the user to reduce the chance that a spam bot can identify a previously encountered image whose corresponding challenge question and answer is known. Those skilled in the art will recognize that there are many methods for accomplishing this alteration without affecting a humans ability to answer a challenge and include changing the color distribution of an image, warping the image, adding random noise to an image, adding a border to an image, and others.

Note that individual components in the challenge package may be requested and delivered over a series of requests and responses instead of in one package from and to one entity. For example, the challenge ID may be requested first by a web server, for example, and that web server may forward that challenge identifier to a web client that has requested a web page from the web server, and then that web client may send a direct request to the challenge server requesting the image and question corresponding to the challenge identifier. In this case, the web server and web client constitute the consumer entity, as alluded to above.

The consumer entity then confirms that the user has entered the correct answer. This is accomplished in the preferred embodiment by the consumer entity sending back an answer along with the unique identifier and the challenge server then sending back a success or failure message.

In an alternative embodiment, the consumer entity can simply request the status of the challenge by sending a status request and the challenge identifier at a minimum to the challenge server. This embodiment is necessary in a case where a consumer entity comprises a server, referred to as the consumer server and a client, referred to as the consumer client, where the consumer server requests a challenge from the challenge server and the consumer client communicates the answer and challenge identifier to the challenge server directly, and where the consumer server needs to ascertain whether or not the challenge has been passed so simply requests the status from the challenge server, assuming that some other entity other than itself has passed the answer to the challenge server.

In another embodiment, when the challenge server receives a request for a challenge, it sends at a minimum, a challenge identifier and the challenge answer or the answer or answers deterministically one-way hashed to a ciphered text to the consumer entity. Those skilled in the art will recognize that this may be a well known one way hash function, such as SHA1, or MD5. It is assumed that if such a function is used instead of the challenge server sending the plain text answer or answers, that the consumer entity knows beforehand what one way hashing function is utilized. The consumer entity has or can request the question to be asked, and can ascertain whether or not the answer entered is correct for the challenge by simply using the same one way hash function with the entered answer and then comparing that hashed result with the hashed result sent from the challenge server. Note that in this embodiment that the consumer entity does not have to communicate with the challenge server after the request has been issued in order to determine if the answer is correct. In the case of multiple answers existing for a given challenge, either multiple hashed answers (or plaintext) are sent to the server or a hash function is used that computes the same hash for any of the allowed answers is used, and that single hashed string is sent to the consumer entity.

The contributor entity is a computer or other machine, or a series of computer or other machines that allow a user or user agent to upload challenges to the challenge server. In the preferred embodiment, a user utilizes a web page to select a picture file for upload, types in a question corresponding to the challenge that he or she believes only a human can answer, types in one or more answers, and then uploads the challenge.

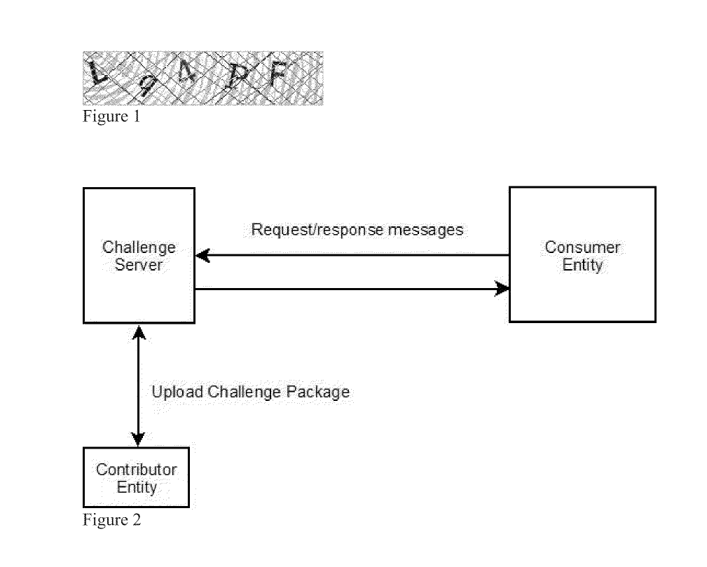

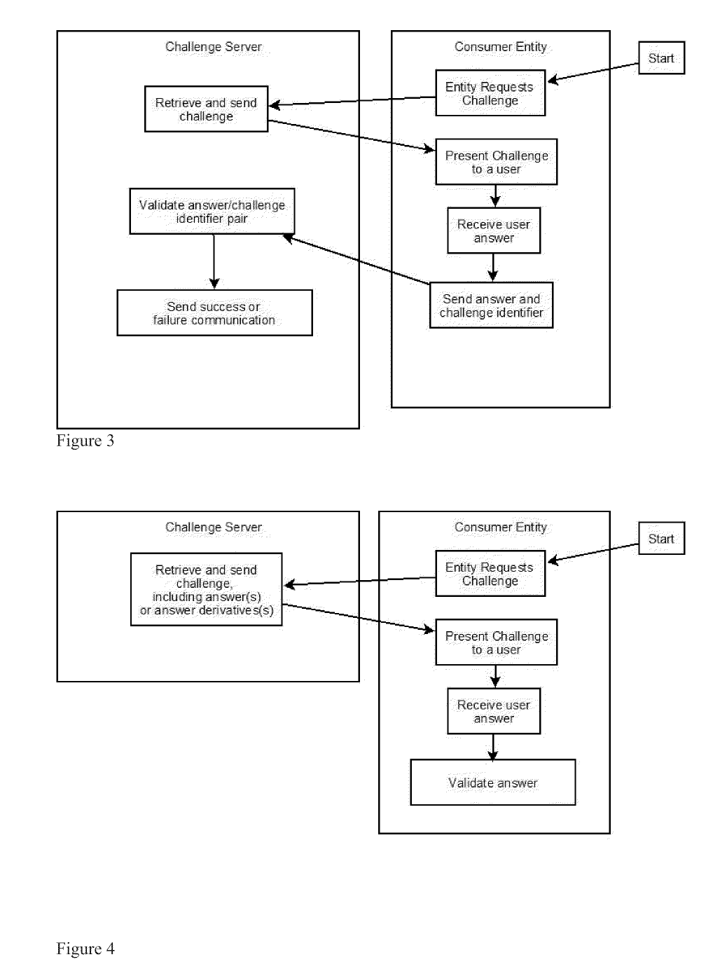

Those skilled in the art will know that there are several variations in which the system can be embodied. FIG. 2 shows the preferred embodiment. A challenge server is a computer or series of computers that can accept a challenge request from a consumer entity, send a challenge package in one or more request/response cycles to a consumer entity, accept an answer from a consumer entity, and send a success or failure response to a consumer entity.

A contributor client is one or more computers or other machines that allow a user to upload a picture, one or more questions associated therewith, and set of answers associated therewith to the challenge server, which is ultimately served to a consumer entity.

A consumer entity is one or more computers or other machines that can pass a request to and receive a response from the challenge server.

A challenge package is a response from the challenge server containing a challenge identifier, and one or more of {a challenge question or questions, a challenge picture or pictures, a challenge audio file, one or more challenge answers, one or more hashes derived from one or more answers}. Note that a challenge package may be broken up and sent over a series of request/response cycles, as described.

A success or failure response is a message communicating the status of a challenge identified by a challenge identifier. It may be communicated in response to a request containing a challenge identifier and zero or more answers.

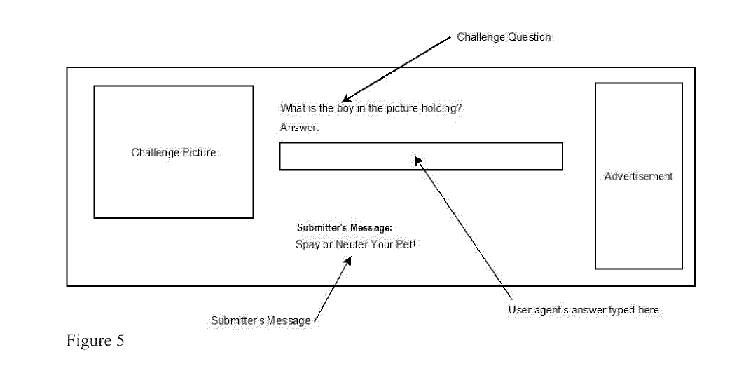

It is contemplated that the invention may be embodied as a widget, which is HTML code that displays a challenge section that may be embedded in the HTML code of a form that a consumer entity displays to a user. The widget would present a picture, or other media to the user, along with a question, and the user would be required to enter a correct answer (in addition to other information on the form). The submitter who originally submitted the challenge might also have the opportunity to add a message and/or link to the challenge, perhaps as an incentive for the submitter. That message might be displayed to the user in the consumer entity (in the widget). Additionally, an advertisement might be delivered along with the challenge. FIG. 5 shows a sample widget created in this fashion.

In one embodiment, the link and/or message that a submitters submits is decoupled from the challenge itself and placed in a pool and presented with other challenges that the user himself has not submitted. This is to avoid a dictionary or reference attack where a spammer associates a particular challenge with a submitter's message/link. By decoupling the submitter's message/link from the baffle he or she submits, a spammer can no longer know what challenge is being presented, and therefore cannot know the answer.

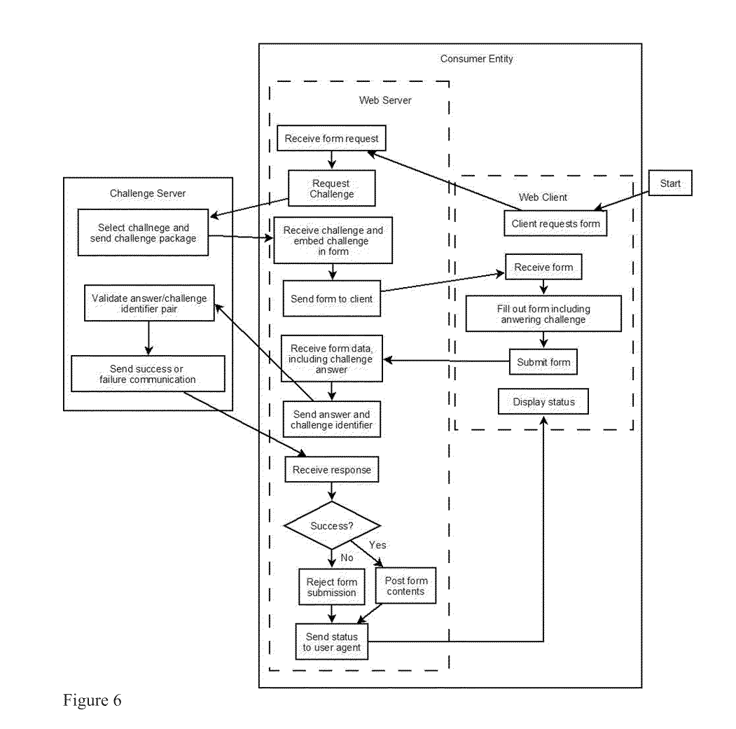

Another alternative embodiment is shown in FIG. 6. In this embodiment, the consumer entity comprises a web server and a web client. Here, the web client requests a page with a form. The web server requests a challenge and the challenge server responds by sending a request challenge package. Note that in this embodiment, the package includes a challenge identifier, an image, and a question—enough information for the web server to present the challenge to the user without needing a follow up request. The web server embeds the challenge in the HTML form and sends the form to the web client. The user (or spam bot) fills out the form, including an answer to the challenge and submits the form. The web server sends the answer and challenge identifier to the challenge server and the challenge server determines whether or not the answer is acceptable for the referenced challenge. It sends a success or failure back to the web server. If the challenge was answered successfully, and there were no other problems with the form, the form contents are posted. Otherwise, the web server rejects the posting. The status is sent back to the user (or spam robot).

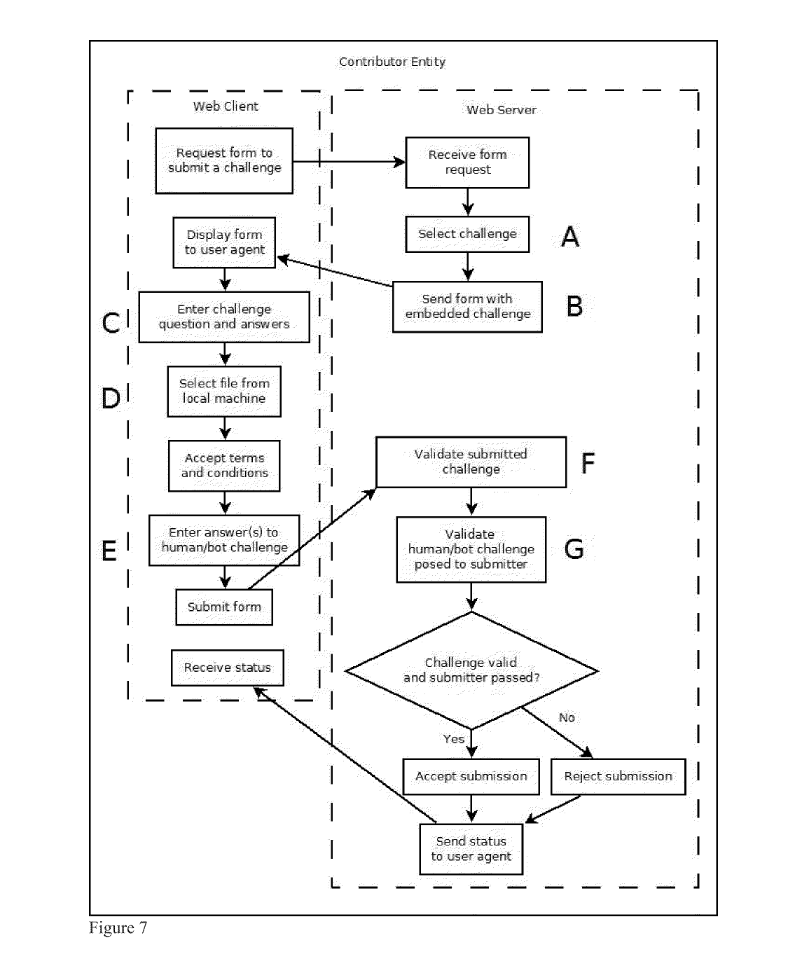

In regards to the ability for users to upload challenges, those skilled in the art will recognize that this can be accomplished in many ways. Two embodiments are discussed here. In the preferred embodiment, the contributor enters a question to be asked, multiple answers, and designates a file that contains the image that the question references. The user then submits this package. FIG. 7 shows this embodiment.

The contributing entity comprises a web server and a web client. This web server may be one or more computers, and may be the same set of computers as the challenge server. The user agent logs into the system and requests a form to input the parameters of the challenge. The web server receives the request and selects a challenge from the challenge server. This challenge is selected (labeled step A in the figure) to ensure that the submitter is not an automated script. It is anticipated that one attempt to crack the challenge system is to flood the challenge server with challenges with known answers in an attempt to increase the likelihood that a spammer will get a challenge of his own making (and to which he knows the answer) when attempting to spam a web site that utilizes the invention.

This challenge is then embedded in the form (step B) and sent to the web client. The form is then displayed. The user then enters the challenge question and answers (step C). Note that in this step, the user is entering the question and answers for the challenge he or she is creating, not entering an answer to the challenge selected in step B. The user then selects a picture or audio file or other media from a local hard drive, for example, accepts the terms and conditions, by clicking on a checkbox, for example.

Next, in order to prove that the submitter is a human, he or she enters an answer to the challenge (step E) that was selected in step B, and then submits the form. The submitted challenge is then validated (step F) to ensure that a question was answered and that at least one answer was submitted, as well as a media file uploaded, for example. The human/robot test that was presented is now validated with the answer entered in step D (step G). If both of these validations pass, the submission is accepted, which might mean it is written to the database. Otherwise, the submission is rejected. The status of the submission is then sent to the user.

An alternate embodiment is envisioned where rather than requiring the user to submit a picture or audio file of his own, he may select one from the existing challenge media pool. This would allow multiple challenges per picture, and would add further security to the system, due to the fact that if a spam bot can automatically identify an image it is not necessarily associated with a unique challenge. For example, given an image of a boy holding a ball in his hand and sitting on a chair, two challenges associated with the image might be “What is the boy holding?” and “What is the boy sitting on?” This embodiment requires one change to FIG. 7. Step D would be replaced with a step where a user selects from a set of images currently available on the challenge server. Those skilled in the art will recognize that there are a variety of ways in which this can be implemented, including an image search (which would require that when users upload images they would also add searchable information, such as tags), allowing a user to view an inventory of images he or she has previously uploaded, and several others.

An additional embodiment incorporates a trusted source contributor that is allowed to upload images and/or questions in batch. This would allow multiple challenges to be uploaded once, for an efficiency gain.

The primary advantage of the invention is that it allows a human interactive proof to determine if a user is a human or automated script in a much more human-friendly way than a CAPTCHA. Further, it enables the large scale collection of image based human interactive proofs by allowing upload to the challenge server by the general public. Third, it makes available this large collection of challenges to many consumer entities, thus lifting the burden of having to collect these challenges themselves. Fourth, it decouples the challenge identifier that is published from the internal challenge identifier using a reference system, thus disallowing a dictionary attack, where a hacker simply tries to associate an answer with a challenge identifier.

What is claimed is:

1) A human verification system comprising a challenge server, a consumer entity, and a contributor entity combination wherein the challenge server comprises one or more computer servers, the contributor entity comprises one or more computer servers and zero or more client computers that interact with the contributor server or with the challenge server directly, and wherein the contributor entity comprises one or more computers, and where the challenge server stores and serves challenges comprising an image, a question that references that image, and one or more answers that answer that question, and where those challenges are submitted by the public.

2) The invention in claim 1 where the consumer entity requests a challenge package in one or more request/response pairs and a challenge package comprises a unique challenge identifier, and 1 or more of {a challenge question, a challenge image, a challenge audio clip, one or more answers, one or more hashed answer strings}

3) The invention in claim 2 where the challenge unique identifier communicated by the challenge server is an instance identifier which indirectly references the unique identifier of the challenge, allowing multiple unique identifiers to the same challenge, and keeping the unique challenge identifier hidden from the consumer entity.

4) The invention in claim 1 where the contributor entity can verify a successful challenge by sending the answer entered and challenge identifier to the challenge server and receive a success/failure response.

5) The invention in claim 1 where the contributor entity can request the status of a challenge identifier where status conveys success or failure.

6) The invention in claim 1 where the challenge entity can determine whether the entered answer is correct based on one or more answers or derivatives thereof sent by the challenge server.

7) The invention in claim 1 where the contributor entity allows a user to add a text message to be circulated with each challenge served by the challenge server.

8) The invention in claim 7 where the text message is a clickable link.

9) The invention in claim 1 where an advertisement is served along with the challenge for consumption by the end user.

10) The invention in claim 1 where the challenge server presents a challenge to the end user comprising an image or an audio recording, a question about the image or audio recording, a submitter's link, a submitter's message and a sponsored link}.

11) The invention in claim 1 where the image is submitted by the public.

12) The invention in claim 1 where the image is provided by the challenge server from a pool of images that already exist on the challenge server.

13) A human/bot detection system comprising a challenge server, a consumer entity, and a contributor entity combination wherein the challenge server comprises one or more computer servers, the contributor entity comprises one or more computer servers and zero or more client computers that interact with the contributor server or with the challenge server directly, and wherein the contributor entity comprises one or more computers, and where the challenge server stores challenges comprising an audio file and one or more answers, and where those challenges are contributed by the public.

14) The invention in claim 13 where the audio file contains a spoken question that corresponds to the correct answers.

15) The invention in claim 13 where a question is contributed along with an audio file and the question references some aspect of the sound or sounds in the audio file.
